(19) United States
(12) Patent Application Publication
(10) Pub. No.: US 2026/0147576 A1
(43) Pub. Date: May 28, 2026

(54) ALTERNATIVE PREDICTION STORAGE

(71) Applicant: Arm Limited, Cambridge (GB)

(72) Inventors: Houdhaifa BOUZGUARROU, Valbonne (FR); Michael Brian SCHINZLER, Round Rock, TX (US); Sergio SCHULER, Austin, TX (US)

(21) Appl. No.: 18/961,907

(22) Filed: Nov. 27, 2024

(51) Int. Cl. G06F 9/38

(52) U.S. Cl. CPC G06F 9/3844; G06F 9/3814; G06F 9/3861

(57) ABSTRACT

An apparatus includes a branch predictor to generate a prediction associated with a branch instruction outcome for a block of at least one instruction. The branch predictor includes: lookup circuitry configured to perform a lookup of stored prediction information to identify a plurality of prediction entries associated with alternative paths of program flow, the plurality of prediction entries comprising a main prediction entry to be used for generating the prediction and one or more alternative prediction entries each associated with an alternative path of program flow; prediction generation circuitry configured to generate the prediction based on the main prediction entry; and alternative prediction storage circuitry configured to store the one or more alternative prediction entries identified by the lookup circuitry; in which responsive to a flush signal indicative of the prediction being incorrect, the prediction generation circuitry is configured to generate an alternative prediction associated with the block of the at least one instruction based on the one or more alternative prediction entries stored by the alternative prediction storage circuitry.

### BACKGROUND

### Technical Field

The present technique relates to the field of data processing. In particular, the present technique relates to branch prediction.

### Technical Background

Data processing devices may comprise branch predictors for predicting whether a branch instruction is to be taken or not taken. Such predictions may be used for controlling the fetching of instructions from a memory system. When a prediction is incorrect, the processing pipeline is flushed of instructions that have been fetched based on that incorrect prediction. Instructions may then begin to be fetched based on the known outcome of a branch instruction until the branch predictor has restarted generating new predictions.

### SUMMARY

At least some examples of the present technique provide an apparatus comprising: a branch predictor to generate a prediction associated with a branch instruction outcome for a block of at least one instruction, the branch predictor comprising: lookup circuitry configured to perform a lookup of stored prediction information to identify a plurality of prediction entries associated with alternative paths of program flow, the plurality of prediction entries comprising a main prediction entry to be used for generating the prediction and one or more alternative prediction entries each associated with an alternative path of program flow; prediction generation circuitry configured to generate the prediction based on the main prediction entry; and alternative prediction storage circuitry configured to store the one or more alternative prediction entries identified by the lookup circuitry; in which responsive to a flush signal indicative of the prediction being incorrect, the prediction generation circuitry is configured to generate an alternative prediction associated with the block of the at least one instruction based on the one or more alternative prediction entries stored by the alternative prediction storage circuitry.

At least some examples of the present technique provide a system comprising: the apparatus described above, implemented in at least one packaged chip; at least one system component; and a board, wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a method comprising: generating a prediction associated with a branch instruction outcome for a block of at least one instruction based on a main prediction entry; performing a lookup of stored prediction information to identify a plurality of prediction entries associated with alternative paths of program flow, the plurality of prediction entries comprising the main prediction entry to be used for generating the prediction and one or more alternative prediction entries each associated with an alternative path of program flow; storing the one or more alternative prediction entries; and in response to a flush signal indicative of the prediction being incorrect, generating an alternative prediction associated with the block of the at least one instruction based on the one or more alternative prediction entries.

At least some examples of the present technique provide a non-transitory computer-readable medium storing computer-readable code for fabrication of an apparatus comprising: a branch predictor to generate a prediction associated with a branch instruction outcome for a block of at least one instruction, the branch predictor comprising: lookup circuitry configured to perform a lookup of stored prediction information to identify a plurality of prediction entries associated with alternative paths of program flow, the plurality of prediction entries comprising a main prediction entry to be used for generating the prediction and one or more alternative prediction entries each associated with an alternative path of program flow; prediction generation circuitry configured to generate the prediction based on the main prediction entry; and alternative prediction storage circuitry configured to store the one or more alternative prediction entries identified by the lookup circuitry; in which responsive to a flush signal indicative of the prediction being incorrect, the prediction generation circuitry is configured to generate an alternative prediction associated with the block of the at least one instruction based on the one or more alternative prediction entries stored by the alternative prediction storage circuitry.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example data processing apparatus according to the present techniques;

FIG. 2 illustrates a sequence of steps for generating predictions;

FIG. 3 illustrates an example configuration of a tagged-geometric length predictor comprising a plurality of storage structures;

FIG. 4 illustrates an example of a set-associative storage structure storing prediction entries;

FIG. 5 illustrates a sequence of steps for generating a prediction using a prediction entry using the tagged-geometric length predictor;

FIG. 6 illustrates an example of main and alternate paths of program flow that may be predicted;

FIG. 7 illustrates a prediction pipeline according to the present techniques; and

FIG. 8 illustrates a system and a chip-containing product.

### DESCRIPTION OF EXAMPLES

In accordance with some example embodiments, there is provided an apparatus comprising a branch predictor configured to generate a prediction associated with a branch instruction outcome for a block of at least one instruction. The branch predictor comprises lookup circuitry configured to perform a lookup of stored prediction information to identify a plurality of prediction entries associated with alternative paths of program flow, the plurality of prediction entries comprising a main prediction entry to be used for generating the prediction and one or more alternative prediction entries each associated with an alternative path of program flow. To generate the prediction, the branch predictor also comprises prediction generation circuitry configured to generate the prediction based on the main prediction entry.

According to the present techniques, the branch predictor also comprises alternative prediction storage circuitry configured to store the one or more alternative prediction entries identified by the lookup circuitry, and responsive to a flush signal indicative of the prediction being incorrect, the prediction generation circuitry is configured to generate an alternative prediction associated with the block of the at least one instruction based on the one or more alternative prediction entries stored by the alternative prediction storage circuitry.

Hence, by storing the one or more alternative prediction entries identified by the lookup circuitry for the prediction, in the event that the prediction is incorrect, an alternative prediction can be generated using the one or more alternative prediction entries without performing a second lookup of the stored prediction information. This results in a faster recovery following a misprediction (i.e. the prediction being incorrect) and faster fetching of subsequent instructions, because the prediction generation circuitry does not need to wait one or more processing cycles for the second lookup to be performed. Accordingly, branch prediction performance in the event of a branch misprediction is increased.

In some examples, the main prediction entry may also be stored by the alternative prediction storage circuitry. When the main prediction entry is also stored, the alternative prediction may be based on the one or more alternative prediction entries and/or the main prediction entry. In some cases aliasing can occur, and so the main prediction entry may be used for both the prediction and the alternative prediction.

In some examples, the lookup circuitry is configured to return the main prediction entry and the one or more alternative prediction entries with the same look-up of stored prediction information. In this way, the alternative prediction, which may in some cases use the one or more alternative prediction entries, may be generated without incurring any additional latency.

In some examples, the prediction generation circuitry is configured to generate the alternative prediction without the lookup circuitry performing a further lookup of the stored prediction information. Hence, as described above, the time and processing resources incurred to perform a second lookup of the stored prediction information in the event of a misprediction can be avoided, thereby increasing branch prediction performance.

In some examples, a prediction pipeline may be present, in which multiple stages of the prediction process may take place. In some examples, the prediction generating circuitry is configured to generate the prediction based on the main prediction entry at a prediction stage of a processing pipeline, and the alternative prediction storage circuitry is configured to return the one or more alternative prediction entries for the alternative prediction at a stage of the processing pipeline earlier than the prediction stage.

When using the prediction pipeline arrangement, the prediction being incorrect may cause prediction pipeline bubbles to occur due to in-progress predictions being flushed from the prediction pipeline, while new predictions begun after prediction is resumed require one or more cycles to reach the prediction stage. The pipeline bubbles then reduce the performance of fetching instructions. In accordance with the present techniques, using the alternative prediction storage circuitry to return the plurality of prediction entries at an earlier point of the prediction pipeline than the prediction stage, the branch predictor can restart fetching more quickly after a flush, i.e. faster by at least one cycle. This reduces the size of the pipeline bubbles. It will be appreciated that the prediction pipeline is not particularly limited, and does not necessitate that the prediction generation circuitry is confined to that prediction pipeline and in some examples, the prediction generation circuitry may span several prediction pipeline stages preceding the prediction stage.

In some examples, the branch predictor comprises at least one set-associative storage structure to store the prediction information, in which the main prediction entry and the one or more alternative prediction entries are from the same set. Hence, by performing a single lookup of the at least one set-associative storage structure, the set containing the main prediction entry and the one or more alternative prediction entries can be returned.

In some examples, the at least one set-associative storage structure comprises sets indexed by a program flow history that is independent of information relating to one or more most recently predicted branch instructions satisfying a program flow update condition. In such examples, looking up the set-associative storage structure based on a given index may result in a hit on multiple entries of the stored prediction information. Accordingly, when looking up the stored prediction information for the prediction, the one or more alternative prediction entries (i.e. the main entry and one or more alternative entries) are identified in the same lookup. These one or more alternative prediction entries may then be stored and used for the alternative prediction in the event of a misprediction using the main prediction entry.

In some examples, the main prediction entry may also be stored by the alternative prediction storage circuitry. In some examples, the alternative prediction may be generated based on the main prediction entry.

By excluding the one or more most recently predicted branch instructions that satisfy the program flow update condition from the information used to generate the set index, the entries in the same set are more likely to provide prediction entries and hence alternative prediction entries that may be of use if a recent branch was mispredicted. This is because, since the set is indexed independently of information relating to a most recently predicted branch instruction, the prediction entries in that set may indicate a prediction for different paths of program flow which may involve different branches as the most recent branch satisfying the program flow history update condition (but which share a common program flow path up to the respective most recently taken branch in those paths). This approach therefore provides a way of obtaining multiple prediction entries relating to alternative paths of program flow in a single lookup of the set-associative storage structure.

The program flow history update condition may be any condition evaluated to determine whether the program flow history should be updated based on a given predicted branch. In some examples, the program flow history update condition may be satisfied for both predicted taken and predicted not-taken branch instructions. However, it will be appreciated that the amount of stored data used to represent the program flow history (and hence frequency of updates) may be reduced by limiting the program flow history update condition to being satisfied for predicted taken branch instructions but not being satisfied for predicted not-taken branch instructions. In some examples, other criteria may also be considered to determine whether the program flow history should be updated based on a given predicted branch (e.g. in implementations using local history buffers, another criterion may be whether the program counter address and/or branch target address of a given branch meets a certain condition, such as being within a particular address range). Hence, the particular program flow history update condition to be satisfied in order for a given predicted branch to cause an update to the program flow history may vary from one embodiment to another, but in general by indexing the set-associative storage structure using an index value which is independent of the most recent branch that caused the program flow history to be updated, this means a number of entries can be maintained in the same set that relate to alternate paths of program flow that are possible paths that could follow a given earlier mispredicted branch.

In some examples, to perform the lookup of stored prediction information to identify the plurality of prediction entries associated with alternative paths of program flow the prediction the lookup circuitry is configured to determine a set of the at least one set-associative storage structure comprising the main prediction entry and the one or more alternative prediction entries.

In some examples, the lookup circuitry is configured to identify the main prediction entry to be used for generating the prediction based on matching a tag value of the main prediction entry with a tag, the tag being dependent on an indication of an address of the block of at least one instruction and on a program flow history that is dependent on the information relating to the one or more most recently predicted branch instructions satisfying the program flow update condition.

When multiple prediction entries are retrieved in a lookup of the set-associative storage structure, some examples may distinguish those prediction entries by storing, in each set, two or more prediction entries in association with a respective tag value to be compared with a tag. The tag is dependent on a portion of the program flow history that is dependent on the information relating to the most recently predicted branch instruction satisfying the program flow update condition. The tag can be compared with tag values stored in each prediction entry within an indexed set, to distinguish which prediction entry should be used as the main prediction entry to generate the prediction. In some examples, all of the plurality of prediction entries within the hit set are then stored by the alternative prediction storage circuitry, and one or more of these may then be used to generate the alternative prediction in the event of a misprediction using the main prediction entry.

In some examples, the indication of the address of the block of at least one instruction comprises a program counter value associated with the block of at least one instruction. In some examples, the program counter may be that of the at least one instruction or another instruction from the block of at least one instruction. The program counter value may also be hashed as part of generating the tag.

It will be appreciated that, in some examples, the index may be further independent of information relating to a second most recently predicted taken branch instruction. This may allow the set-associative storage structure to hit on more entries but at the cost of prediction accuracy. In examples that are configured for particularly aggressive prediction, increasing the independence of the index from recently taken branch instructions can allow the alternate path predictions to be generated even further into the future. For example, further alternative predictions may be generated in respect of further branch instructions expected to be encountered beyond what is currently predicted for the alternative prediction, thereby extending the alternative prediction.

The at least one set-associative storage structure may comprise a plurality of set-associative storage structures. Each of these may be associated with a different program flow history length. In some examples, there is a long-history storage structure associated with a long history length and a short-history storage structure associated with a short history length.

In some examples, the lookup circuitry is configured to identify a set comprising the plurality of prediction entries based on determining a hit in a set-associative storage structure of the plurality of set-associative storage structures having a longest program flow history length. Matching a prediction entry against a longer history of program flow is indicative that a prediction generated in dependence on that prediction entry is more likely to be accurate.

One example of such a prediction mechanism is a tagged-geometric length (TAGE) predictor. Hence, in some examples, the at least one set-associative storage structure comprises at least one TAGE table.

In some examples, for a subsequent prediction, the lookup circuitry is configured to perform a lookup of stored prediction information from a prediction resumption address selected based on the alternative prediction. Hence, the branch predictor may continue generating predictions after the alternative prediction.

In some examples, each prediction entry of the plurality of prediction entries comprises prediction information indicating one or more of: a predicted branch direction, and a confidence of the prediction being correct. Hence, relevant information for the prediction can be efficiently determined based on the prediction entry.

In some examples, the alternative prediction storage circuitry is configured to store the plurality of prediction entries in an alternative prediction cache. Hence, the plurality of prediction entries may be accessed in a fast and efficient manner for the alternative prediction, reducing the likelihood of introducing a delay to the alternative prediction generation.

In some examples, the alternative prediction storage circuitry is configured to store the plurality of prediction entries in a circular buffer. Hence, over time, the older prediction entries may be overwritten, increasing the likelihood that the most relevant prediction entries are stored by the alternative prediction storage circuitry.

Specific examples are now explained with reference to the drawings.

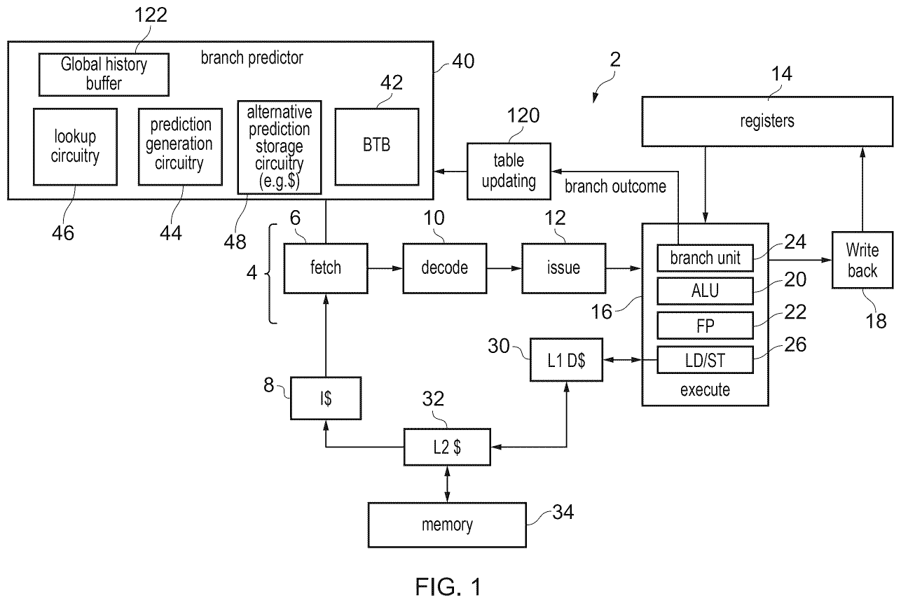

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor a register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage 16. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 26 for performing load/store operations to access data in a memory system 8, 30, 32, 34.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

As shown in FIG. 1, the apparatus 2 includes a branch predictor 40 for predicting outcomes of branch instructions. The branch predictor 40 is looked up based on addresses of instructions provided by the fetch stage 6 and provides a prediction on whether those instructions are predicted to include branch instructions, and for any predicted branch instructions, a prediction of their branch properties such as a branch type, branch target address and a branch direction (predicted branch outcome, indicating whether the branch is predicted to be taken or not taken).

The branch predictor 40 includes a branch target buffer (BTB) 42 for predicting properties of the branches other than branch direction, and prediction generation circuitry 44 for generating predictions, such as a branch direction. The prediction generation circuitry 44 may be or comprise a branch direction predictor (BDP) for predicting the not taken/taken outcome (branch direction).

It will be appreciated that the branch predictor 40 could also include other prediction structures such as a call-return stack for predicting return addresses of function calls, a loop direction predictor for predicting when a loop controlling instruction will terminate a loop, or other more specialised types of branch prediction structures for predicting behaviour of outcomes in specific scenarios.

The branch predictor 40 also has a global history buffer 122, which maintains a program flow history based on predicted branch instructions satisfying the program flow update condition. The program flow history represents a history of program flow preceding a current point of program flow for which a branch prediction is to be made. For example, each time a predicted branch instruction is predicted to occur by the branch predictor 40 that satisfied a program flow update condition, information about that branch (e.g. information derived from the program counter address and/or branch target address and/or taken/not-taken outcome of the branch) can be logically inserted into the global history buffer 122. The global history buffer 122 may function logically as a first-in-first-out buffer (in some implementations implemented as a circular buffer based on pointers tracking the point of the buffer at which the next entry should be inserted), so that the oldest entry may be overwritten by new information if there is no remaining invalid entry in the buffer. Hence, the global history buffer 122 tracks information about a certain number of recently predicted branches.

The program flow history update condition used to determine whether a given predicted branch instruction should cause an update of the program flow history may vary depending on implementation choice. In some examples, all predicted branches may cause an update of the program flow history. In other examples, the program flow history update condition may be satisfied when a predicted branch is predicted taken but not when the predicted branch is predicted not-taken.

In some examples, the program flow history update condition could also depend on other properties of the branch other than taken/not-taken outcome. For example, the program counter address and/or branch target address of the branch may be used to determine whether the program flow history update condition is satisfied. For example, the global history buffer 122 could comprise a number of local history buffers each updated based on branches with instruction addresses within a respective address range corresponding to that buffer, and in that case the instruction address (program counter address) of the branch may be checked to determine whether the program flow history update condition is satisfied.

Regardless of the particular program flow history update condition used for a given example of the global history buffer 122, the tracked program flow history can be used to form information used to lookup stored prediction information. For example, the program flow history can be used to generate index information and/or tags for looking up a set-associative storage structure that stores the prediction information, as discussed in more detail below.

As shown in FIG. 1, the apparatus 2 may have table updating circuitry 120 which receives signals from the branch unit 24 indicating the actual branch outcome of instructions, such as indications of whether a taken branch was detected in a given block of instructions, and if so the detected branch type, target address or other properties. If a branch was detected to be not taken then this is also provided to the table updating circuitry 120. The table updating circuitry 120 then updates state within the BTB 42, the prediction generation circuitry 44 (e.g. a BDP) and other branch prediction structures to take account of the actual results seen for an executed block of instructions, so that it is more likely that on encountering the same block of instructions again then a correct prediction can be made.

To generate a prediction, branch predictor 40 includes lookup circuitry 46 configured to perform a lookup of stored prediction information to identify a plurality of prediction entries associated with alternative paths of program flow, the plurality of prediction entries comprising a main prediction entry to be used for generating the prediction and one or more alternative prediction entries each associated with an alternative path of program flow. Branch predictor 40 also includes alternative prediction storage circuitry 48 (e.g. a cache) for storing the one or more prediction entries identified by the lookup circuitry 46.

In the event of a misprediction and responsive to a flush signal, the prediction generation circuitry 44 is configured to generate an alternative prediction associated with the block of the at least one instruction based on the one or more alternative prediction entries stored by the alternative prediction storage circuitry.

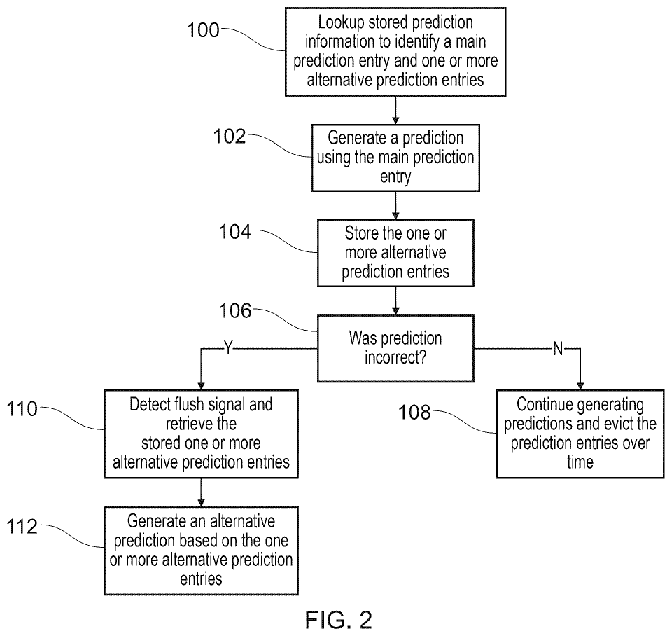

FIG. 2 illustrates a sequence of steps for generating predictions associated with a branch instruction outcome for a block of at least one instruction. The process begins at step 100 in which a lookup of stored prediction information is performed to identify a plurality of prediction entries comprising a main prediction entry and one or more alternative prediction entries. As discussed herein, the prediction information may be stored in one or more set-associative storage structures (such as one or more TAGE tables) and the lookup may identify a set within the one or more set-associative storage structures which contains the plurality of prediction entries. In this way, a single lookup may be performed to identify the main prediction entry and the one or more alternative prediction entries. At step 102, a prediction using the main prediction entry is generated. This may also include controlling a fetch stage (e.g. fetch stage 6 of FIG. 1) based on the generated prediction. At step 104, the one or more alternative prediction entries are stored by the alternative prediction storage circuitry (e.g. in a cache). The main prediction entry may also be stored at step 104. At step 106, it is determined whether the prediction based on the main prediction entry was incorrect. This may be determined by receiving a flush signal from the branch unit 24 of FIG. 1, for example. It will be appreciated that for some execution pipelines, steps 100 to 104 may be repeated in respect of different branch instructions before the determination of step 106 can be performed. Hence, it will be understood that the process of FIG. 2 is only in respect of one branch instruction.

If the prediction is determined to be correct, then at step 108, the branch predictor 40 continues generating predictions as normal. The one or more alternative prediction entries 9 and in some examples also the main prediction entry) may be eventually evicted from the alternative prediction storage circuitry (e.g. from the cache), for example according to an eviction policy that is enforced when allocating new prediction entries to the cache.

If the prediction is determined to be incorrect, then at step 110, a flush signal is detected and the one or more alternative prediction entries (and in some cases also the main prediction entry) that have been stored are retrieved. At step 112, the prediction generation circuitry 44 generates an alternative prediction based on the one or more alternative prediction entries (and in some examples also the main prediction entry). It will be appreciated that information of the alternative prediction may also be communicated to the fetch stage 6, which restarts fetching instructions after the mispredicted branch instruction based on the alternate path of program flow. In some examples, for a subsequent prediction, the lookup circuitry 46 is configured to perform a lookup of stored prediction information form a prediction resumption address selected based on the alternative prediction.

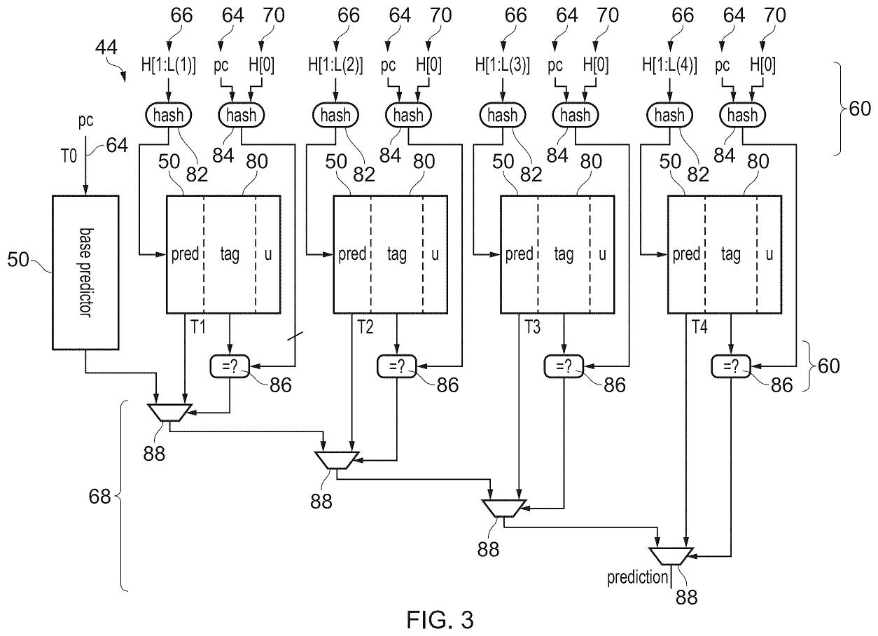

FIG. 3 shows a specific example of a prediction mechanism that may be implemented into the branch predictor 40, e.g. as the prediction generation circuitry 44 (e.g. a BDP). The prediction mechanism is a tagged-geometric (TAGE) predictor for which the branch prediction tables 50 include a base prediction table T0 and a number of TAGE tables T1 to T4, which are each arranged as set-associative storage structures. While this example shows 4 TAGE tables for conciseness, it will be appreciated that the TAGE predictors could be provided with a larger number of tables if desired, e.g. 8 or 16. The base predictor TO is indexed based on the program counter PC 64 alone, while the TAGE tables T1 to T4 are indexed based on a hash value generated by applying a hash function 82 to successively increasing lengths of history information 66, so that T1 uses a shorter sequence of history information compared to T2, T2 uses a shorter sequence of history information compared to T3, and so on. In this example, T4 is the table which uses the longest sequence of history information.

The index generated by the hash function 82 is used to select which particular entry of the TAGE table 50 is read when looking up the tables 50. The history information 66 used to generate the index value is derived from the program flow history tracked by the history tracking circuitry 125 discussed above, and comprises information on recently predicted branch instructions that have fulfilled a program flow history update condition (e.g. branch instructions that were predicted taken, in some specific examples). For the purposes of indexing, the history information 66 excludes a most recently predicted branch instruction satisfying the program flow history update condition. For example, if the program flow history update condition is satisfied only for taken branch instructions, the index is independent of information relating to a most recently predicted branch instruction. Hence, where the program flow history was updated based on branches A, B, C, and D, the portion of the program flow history used as history information 66 for generating the index value used may only represent information about branches A, B, and C and excludes information about branch D. Prediction entries in the corresponding set may therefore indicate prediction information relating to a history of A, B, C, and D and A, B, C, and D′ (where D′ indicates a different branch to branch D, which might arise following differences in predicted outcomes for one of branches C or D or an intervening branch). Accordingly, it is possible to identify two or more prediction entries in a single lookup of each TAGE table, which each relate to a shared earlier portion of program flow history (e.g. the history corresponding to branches A, B and C) but which then diverge (e.g. with differences between branch D and branch D′), and hence two or more predictions may be generated relating to alternate paths that are possible around a given point of program flow.

Hence, in this example, the index for table T1 is based on history information H[1:L(1)], the index for table T2 is based on history information H[1: L(2)], the index for table T3 is based on history information H[1:L(3)], and the index for table T4 is based on history information H[1:L(4)], where L4>L3>L2>L1 so that each TAGE table uses a progressively longer sequence of history, but the index for each table is generated based on information excluding the entry H[0] representing the most recent predicted branch that caused the history to be updated.

Each prediction entry specifies a prediction counter (“pred”), for example a 2-bit counter which provides a bimodal indication of whether the prediction is to be taken or not taken (e.g. counter values 11, 10, 00, 01 may respectively indicate predictions of: strongly predicted taken, weakly predicted taken, weakly predicted not taken, and strongly predicted not taken). Each entry also specifies a tag value 80 which is compared with a tag hash generated in dependence on an indication of the current block of instructions, i.e. the PC 64, and the history information 70 relating to the most recently predicted branch instruction, i.e. branch D from the above example. In FIG. 3, the most recently predicted branch instruction is represented by H[0], which is not included in the history information 66 used in indexing but is used for the tag generation hash 84. While in this example the tag hash does not depend on other entries of the history tracked by history tracking circuitry 125 (entries H[1] onwards of the history information are used for the index hash 82 but not the tag hash 84), other examples could also consider one or more of history entries H[1] onwards in the tag hash function).

The tag hash is used distinguish between multiple prediction entries whose index hash values alias onto the same set of the table. The lookup circuitry includes index hashing circuitry 82 for generating the index hash for indexing into a selected set of the table, tag hashing circuitry 84 for generating a tag hash value to be written to a newly allocated prediction entry or for comparing with an existing prediction entry's tag value 80 on a lookup, and comparison circuitry 86 for comparing the tag value 80 read out from a looked up entry with the calculated tag hash generated by the tag hashing circuitry 84 to determine whether a hit has been detected.

For a TAGE predictor, the TAGE prediction generating circuitry 68 comprises a cascaded sequence of selection multiplexers 88 which select between the alternative predictions returned by any of the prediction tables 50 which generate a hit. The base predictor 50 may always be considered to generate a hit, and is used as a fall-back predictor in case none of the other TAGE tables generate a hit (a hit occurs when the tag in the looked up entry matches the tag hash generated based on the indexing information). The cascaded multiplexers are such that if the table T4 indexed with the longest sequence of history generates a hit then its prediction will be output as the prediction result, but if it misses then if the preceding table T3 generates a hit then the T3 prediction will be output as the overall prediction for the current block, and so on, so that the prediction which gets selected is the prediction output by the table (among those tables which generated a hit) which corresponds to the longest sequence of history considered in the indexing. That is, any tables which miss are excluded from the selection, and among the remaining tables the one with the longest sequence of history in its indexing information is selected, and if none of the TAGE tables T1 to T4 generate a hit then the base predictor T0 is selected.

This approach is extremely useful for providing high performance because a single table indexed with a fixed length of branch history has to trade off the accuracy of predictions against the likelihood of lookups hitting in the table. A table indexed with a relatively short sequence of branch history may be more likely to generate a hit, because it is more likely that the recently seen history leading to the current block is the same as a previously seen sequence of history for which an entry is recorded in the table, but as the shorter sequence of history cannot distinguish as precisely between the different routes by which the program flow may have reached the current block, it is more likely that the prediction indicated in the hit entry may be incorrect. On the other hand, for the table T4 which is indexed based on the longest sequence of history, this can be extremely useful for predicting harder to predict branches which need to delve further into the past in terms of exploring the history so that that the pattern of program execution which led to that branch can be characterised and an accurate prediction made, however, it is less likely on subsequent occasions that the longer sequence of history will exactly match the sequence of history leading up to the current block and so the hit rate is lower in a table indexed based on a longer sequence of history. By providing a range of tables with different lengths of history used for indexing, this can balance these factors so that while the hardest to predict branches which would be difficult to predict using other branch predictors can be successfully predicted with the longer table T4, other easier to predict branches which do not require the full prediction capability of T4 can be predicted using one of the earlier tables indexed based on shorter history so that it is more likely that a hit will be detected on a prediction lookup, thus increasing the percentage of branches for which a successful prediction can be made and therefore improving prediction accuracy and performance. Hence, TAGE predictors are one of the most accurate predictors known.

By indexing the TAGE tables T1 to T4 independently of information H[0] relating to a most recently predicted branch instruction satisfying the program flow history update condition, a single lookup of the TAGE predictor can hit on an indexed set comprising two or more prediction entries which are likely to relate to alternate paths of program flow which might be useful if the main path prediction turns out to be incorrect. A prediction entry to be used for generating the main path prediction is identified by comparing the tag hash value, which is dependent on information relating to a most recently predicted branch instruction. An entry that does not match the tag hash value (but does match the index hash) may relate to a different branch instruction (e.g. in a different block of instructions), but has a similar history of predicted branches (excluding the most recent branch satisfying the program flow history update condition). Hence, such an entry may be used for generating an alternate path prediction without incurring the latency of an additional lookup of the full TAGE structure, by caching the alternate path prediction for use when recovering from a flush.

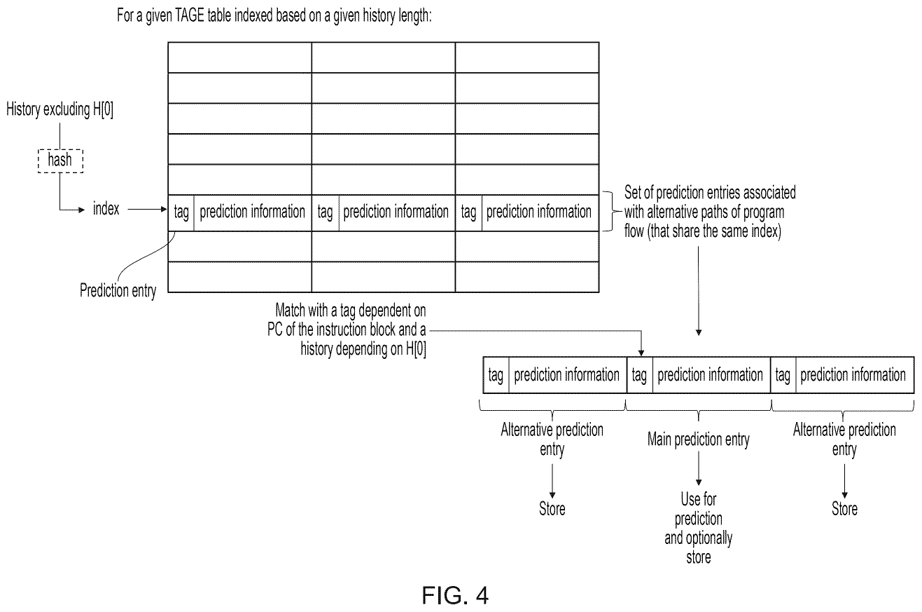

FIG. 4 illustrates a set that may be hit in one of the TAGE tables T1 to T4. The history excluding H[0] (the information on the most recent predicted branch satisfying the program flow update condition) is hashed by the index hashing circuitry 82 to obtain an index to the TAGE table. In this example, the index hits on a set containing three prediction entries (three entries are shown for conciseness, but in practice the number of entries in one set may be a power of 2). Each entry in the set may be indicative of different paths of program flow. Each prediction entry is also stored in association with a respective tag value. The tag values are compared with a tag generated by the tag hashing circuitry 84 based on the PC 64 and information H[0] relating to the most recently predicted branch instruction that satisfied the program flow history update condition, to identify the prediction entry to be used for generating the prediction (i.e. the main prediction entry). The other remaining prediction entries (i.e. that matched the index, but did not match the tag) are the one or more alternative prediction entries which may then be stored by the alternative prediction storage circuitry 48 and used for a subsequent prediction in the event that the prediction using the main prediction entry is incorrect. In some examples, the main prediction entry is also stored by the alternative prediction storage circuitry 48.

It will be appreciated that while the present techniques may include the index being independent of the most recently predicted branch instruction satisfying the program flow history update condition, more aggressive examples may use an index that is independent of information relating to the N most recently predicted branch instructions satisfying the program flow history update condition, where N is an integer greater than 1. This causes the set-associative structures to hit on more entries thereby allowing for more predictions, at the cost of accuracy. This may allow further identification of alternate paths that encompass a greater number of branches ahead of the point at which a misprediction is detected.

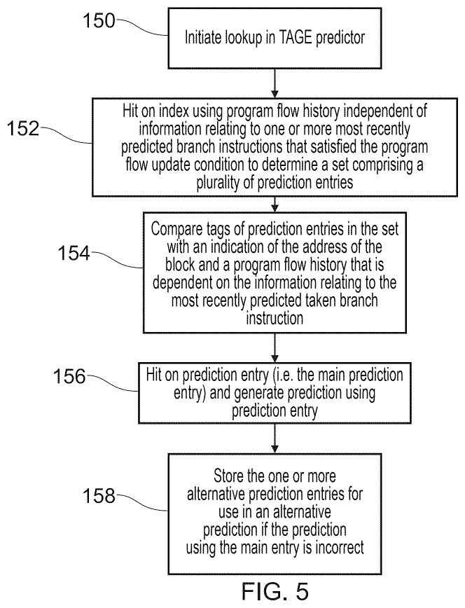

FIG. 5 illustrates a sequence of steps for using a TAGE predictor for generating a main path prediction and an alternate path prediction. The process begins at step 150 in which a (single) lookup is initiated in the TAGE predictor. Initiating a lookup may include generating hash values for the index hash and/or tag hash based on the PC 64 and the history information 66, 70 tracked by the global history buffer 122. At step 152, a hit is detected on an index using the program flow history independent of information relating to a most recently predicted branch instruction that satisfied the program flow history update condition. The hit identifies a set in the set-associative TAGE tables, where the set contains two or more prediction entries. At step 154, the tags of each prediction entry in the set are compared with a tag value generated based on the current block and a program flow history that is dependent on the information relating to the most recently predicted branch instruction that satisfied the program flow history update condition. If there is a hit on the tag value comparisons, then at step 156, a prediction is generated based on the hit prediction entry (i.e. the main prediction entry). At step 158, any other prediction entries in the set are stored by the alternative prediction storage circuitry 48, such as in a cache. It will be appreciated that the main prediction entry may also be stored by the alternative prediction storage circuitry 48 (e.g. also in the cache). These stored prediction entries may then be used for a subsequent alternative prediction in the event that the prediction based on the main prediction entry was incorrect, thereby avoiding a second lookup of stored prediction information to generate the alternative prediction.

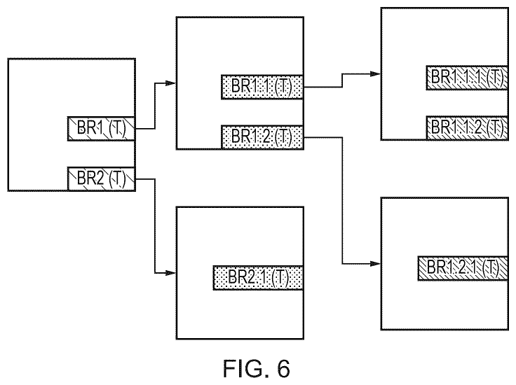

An example of how different paths of program flow may be predicted based on entries sharing the same index in the TAGE tables is shown by FIG. 6. In this example, the program flow history update condition is satisfied when a predicted branch is taken, but is not satisfied for not-taken predicted branches. It will be appreciated that other examples could use a different program flow history update condition and hence the pattern of which branches share the same index value may differ from that shown in the example of FIG. 6.

In this example, BR1.1, BR1.2, BR2.1 will share the same index value because the history information used to generate the index for these branch lookups will exclude information on the most recent taken branch (BR1 for BR1.1 and BR1.2, and BR2 for BR2.1-note that to reach BR1.2, BR1.1 must be not-taken so does not count as a most recent taken branch when looking up information for BR1.2). Similarly, the entries for branches BR1.1.1, BR1.1.2, BR1.2.1 share the same index because their index hash excludes information relating to the most recent taken branch BR1.1 or BR1.2.

While allocating such entries to the same set can cause additional pressure on the TAGE as multiple paths map to the same set, this can be useful to peek into alternate paths without requiring any additional TAGE lookup, as described herein.

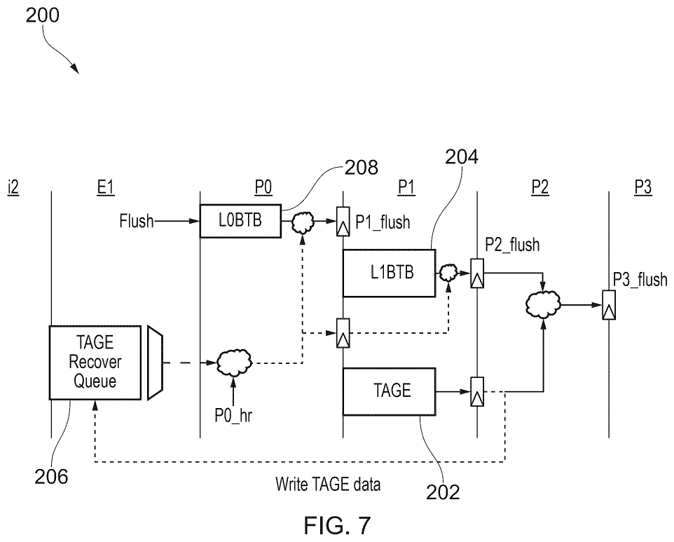

FIG. 7 illustrates an example embodiment incorporating the present techniques arranged in a prediction pipeline 200. The prediction pipeline 200 comprises a plurality of stages comprising control stage E1 and prediction stages P0, P1 and P2. In some examples, there are a plurality of control stages. In some examples, the one or more control stages and prediction stages may overlap. In this example, the prediction structure incorporates a TAGE predictor 202, but it will be appreciated that other prediction structures may be used instead. The TAGE predictor 202 is configured to return any generated predictions in the prediction stages, in particular at the end of stage P1.

Although not shown, the control stage may comprise a global history register/buffer in which the history of program flow may be stored for indexing into the TAGE predictor 202. Hence, in the control stage E1, the global history register may output the index for looking up the TAGE predictor 202 to generate a prediction in respect of an input branch instruction. The TAGE predictor 202 may then return a predicted direction for the prediction in stage P1, which is then combined in stage P2 with a predicted target address retrieved from a BTB 204. Hence, this prediction is ready in P3.

On a mispredict, the prediction pipeline 200 flushes the pipeline and starts predicting a new path, and this can cause one or more bubbles in the pipeline. For example, a flush at P3 can cause a bubble of two cycles (as the P1 and P2 stages are flushed and then empty).

Looking up the TAGE predictor 202 using the index identifies a plurality of prediction entries from a hit set. The main prediction entry from the plurality of prediction entries is used to by the TAGE predictor 202 to generate the prediction. The one or more alternative prediction entries (and in some examples also the main prediction entry) each associated with an alternative path of program flow are stored in the TAGE recover queue 206 (which is an example of the alternative prediction storage circuitry 48). The TAGE recover queue 206 in this example is configured to return the one or more alternative prediction entries at the control stage E1, which appears earlier in the prediction pipeline 200 than the prediction stage P2 or P3 at which the prediction based on the main prediction entry would be available based on looking up the TAGE 202. Hence, the stored prediction entries are available for use one or two cycles earlier (depending on whether P2 or P3 was flushed).

Thus, the stored prediction entries from the TAGE recover queue 206 can be combined with a predicted target address retrieved from BTB 208 at stage P0, and the alternative prediction is available one or two cycles earlier than waiting to perform a second lookup of the TAGE predictor 202.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

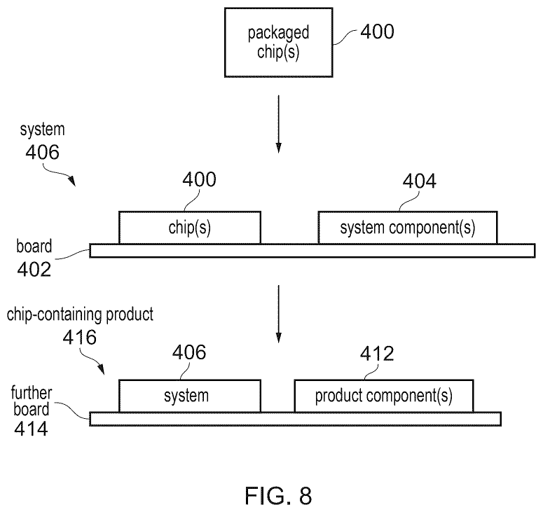

As shown in FIG. 8, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:

1. An apparatus comprising:
a branch predictor to generate a prediction associated with a branch instruction outcome for a block of at least one instruction, the branch predictor comprising:
lookup circuitry configured to perform a lookup of stored prediction information to identify a plurality of prediction entries associated with alternative paths of program flow, the plurality of prediction entries comprising a main prediction entry to be used for generating the prediction and one or more alternative prediction entries each associated with an alternative path of program flow;
prediction generation circuitry configured to generate the prediction based on the main prediction entry; and
alternative prediction storage circuitry configured to store the one or more alternative prediction entries identified by the lookup circuitry; in which
responsive to a flush signal indicative of the prediction being incorrect, the prediction generation circuitry is configured to generate an alternative prediction associated with the block of the at least one instruction based on the one or more alternative prediction entries stored by the alternative prediction storage circuitry.

2. The apparatus of clause 1, in which the lookup circuitry is configured to return the main prediction entry and the one or more alternative prediction entries with the same look-up of stored prediction information.

3. The apparatus of any preceding clause, in which the prediction generation circuitry is configured to generate the alternative prediction without the lookup circuitry performing a further lookup of the stored prediction information.

4. The apparatus of any preceding clause, in which the prediction generating circuitry is configured to generate the prediction based on the main prediction entry at a prediction stage of a processing pipeline, and the alternative prediction storage circuitry is configured to return the one or more alternative prediction entries for the alternative prediction at a stage of the processing pipeline earlier than the prediction stage.

5. The apparatus of any preceding clause, in which the branch predictor comprises at least one set-associative storage structure to store the prediction information, in which the main prediction entry and the one or more alternative prediction entries are from the same set.

6. The apparatus of clause 5, in which the set-associative storage structure comprises sets indexed by a program flow history that is independent of information relating to one or more most recently predicted taken branch instructions satisfying a program flow update condition.

7. The apparatus of clause 5 or 6, in which to perform the lookup of stored prediction information to identify the plurality of prediction entries associated with alternative paths of program flow the prediction the lookup circuitry is configured to determine a set of the at least one set-associative storage structure comprising the main prediction entry and the one or more alternative prediction entries.

8. The apparatus of any of clauses 5 to 7, in which the lookup circuitry is configured to identify the main prediction entry to be used for generating the prediction based on matching a tag value of the main prediction entry with a tag, the tag being dependent on an indication of an address of the block of at least one instruction and on a program flow history that is dependent on the information relating to the one or more most recently predicted taken branch instructions satisfying a program flow update condition.

9. The apparatus of clause 8, in which the indication of the address of the block of at least one instruction comprises a program counter value associated with the block of at least one instruction.

10. The apparatus of any of clauses 5 to 9, in which
the at least one set-associative storage structure comprises a plurality of set-associative storage structures, each associated with a different program flow history length, and wherein
the lookup circuitry is configured to identify a set comprising the plurality of prediction entries based on determining a hit in a set-associative storage structure of the plurality of set-associative storage structures having a longest program flow history length.

11. The apparatus of any of clauses 5 to 10, in which the at least one set-associative storage structure comprises at least one tagged-geometric (TAGE) table.

12. The apparatus of any preceding clause, in which, for a subsequent prediction, the lookup circuitry is configured to perform a lookup of stored prediction information from a prediction resumption address selected based on the alternative prediction.

13. The apparatus of any preceding clause, in which each prediction entry of the plurality of prediction entries comprises prediction information indicating one or more of: a predicted branch direction, and a confidence of the prediction being correct.

14. The apparatus of any preceding clause, in which the alternative prediction storage circuitry is configured to store the one or more alternative prediction entries in an alternative prediction cache.

15. The apparatus of any preceding clause, in which the alternative prediction storage circuitry is configured to store the one or more alternative prediction entries in a circular buffer.

16. A system comprising:
the apparatus of any preceding clause, implemented in at least one packaged chip;
at least one system component; and
a board,
wherein the at least one packaged chip and the at least one system component are assembled on the board.

17. A chip-containing product comprising the system of clause 16, wherein the system is assembled on a further board with at least one other product component.

18. A method comprising:
generating a prediction associated with a branch instruction outcome for a block of at least one instruction based on a main prediction entry;
performing a lookup of stored prediction information to identify a plurality of prediction entries associated with alternative paths of program flow, the plurality of prediction entries comprising the main prediction entry to be used for generating the prediction and one or more alternative prediction entries each associated with an alternative path of program flow;
storing the one or more alternative prediction entries; and
in response to a flush signal indicative of the prediction being incorrect, generating an alternative prediction associated with the block of the at least one instruction based on the one or more alternative prediction entries.

19. A non-transitory computer-readable medium storing computer-readable code for fabrication of an apparatus comprising:
a branch predictor to generate a prediction associated with a branch instruction outcome for a block of at least one instruction, the branch predictor comprising:
lookup circuitry configured to perform a lookup of stored prediction information to identify a plurality of prediction entries associated with alternative paths of program flow, the plurality of prediction entries comprising a main prediction entry to be used for generating the prediction and one or more alternative prediction entries each associated with an alternative path of program flow;
prediction generation circuitry configured to generate the prediction based on the main prediction entry; and
alternative prediction storage circuitry configured to store the one or more alternative prediction entries identified by the lookup circuitry; in which
responsive to a flush signal indicative of the prediction being incorrect, the prediction generation circuitry is configured to generate an alternative prediction associated with the block of the at least one instruction based on the one or more alternative prediction entries stored by the alternative prediction storage circuitry.

In the present application, the words “configured to . . .” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
a branch predictor configured to generate a prediction associated with a branch instruction outcome for a block of at least one instruction, the branch predictor comprising:
lookup circuitry configured to perform a lookup of stored prediction information to identify a plurality of prediction entries associated with alternative paths of program flow, the plurality of prediction entries comprising a main prediction entry to be used for generating the prediction and one or more alternative prediction entries each associated with an alternative path of program flow;
prediction generation circuitry configured to generate the prediction based on the main prediction entry; and
alternative prediction storage circuitry configured to store the one or more alternative prediction entries identified by the lookup circuitry; in which
responsive to a flush signal indicative of the prediction being incorrect, the prediction generation circuitry is configured to generate an alternative prediction associated with the block of the at least one instruction based on the one or more alternative prediction entries stored by the alternative prediction storage circuitry.

2. The apparatus of claim 1, in which the lookup circuitry is configured to return the main prediction entry and the one or more alternative prediction entries with the same look-up of stored prediction information.

3. The apparatus of claim 1, in which the prediction generation circuitry is configured to generate the alternative prediction without the lookup circuitry performing a further lookup of the stored prediction information.

4. The apparatus of claim 1, in which the prediction generating circuitry is configured to generate the prediction based on the main prediction entry at a prediction stage of a processing pipeline, and the alternative prediction storage circuitry is configured to return the one or more alternative prediction entries for the alternative prediction at a stage of the processing pipeline earlier than the prediction stage.

5. The apparatus of claim 1, in which the branch predictor comprises at least one set-associative storage structure configured to store the prediction information, in which the main prediction entry and the one or more alternative prediction entries are from the same set.

6. The apparatus of claim 5, in which the set-associative storage structure comprises sets indexed by a program flow history that is independent of information relating to one or more most recently predicted branch instructions satisfying a program flow update condition.

7. The apparatus of claim 5, in which to perform the lookup of stored prediction information to identify the plurality of prediction entries associated with alternative paths of program flow, the prediction the lookup circuitry is configured to determine a set of the at least one set-associative storage structure comprising the main prediction entry and the one or more alternative prediction entries.

8. The apparatus of claim 5, in which the lookup circuitry is configured to identify the main prediction entry to be used for generating the prediction based on matching a tag value of the main prediction entry with a tag, the tag being dependent on an indication of an address of the block of at least one instruction and on a program flow history that is dependent on the information relating to the one or more most recently predicted branch instructions satisfying a program flow update condition.

9. The apparatus of claim 8, in which the indication of the address of the block of at least one instruction comprises a program counter value associated with the block of at least one instruction.

10. The apparatus of claim 5, in which:
the at least one set-associative storage structure comprises a plurality of set-associative storage structures, each associated with a different program flow history length, and wherein
the lookup circuitry is configured to identify a set comprising the plurality of prediction entries based on determining a hit in a set-associative storage structure of the plurality of set-associative storage structures having a longest program flow history length.

11. The apparatus of claim 5, in which the at least one set-associative storage structure comprises at least one tagged-geometric (TAGE) table.

12. The apparatus of claim 1, in which, for a subsequent prediction, the lookup circuitry is configured to perform a lookup of stored prediction information from a prediction resumption address selected based on the alternative prediction.

13. The apparatus of claim 1, in which each prediction entry of the plurality of prediction entries comprises prediction information indicating one or more of: a predicted branch direction, and a confidence of the prediction being correct.

14. The apparatus of claim 1, in which the alternative prediction storage circuitry is configured to store the one or more alternative prediction entries in an alternative prediction cache.

15. The apparatus of claim 1, in which the alternative prediction storage circuitry is configured to store the one or more alternative prediction entries in a circular buffer.

16. A system comprising:
the apparatus of claim 1, implemented in at least one packaged chip;
at least one system component; and
a board,
wherein the at least one packaged chip and the at least one system component are assembled on the board.

17. A chip-containing product comprising the system of claim 16, wherein the system is assembled on a further board with at least one other product component.

18. A method comprising:
generating a prediction associated with a branch instruction outcome for a block of at least one instruction based on a main prediction entry;
performing a lookup of stored prediction information to identify a plurality of prediction entries associated with alternative paths of program flow, the plurality of prediction entries comprising the main prediction entry to be used for generating the prediction and one or more alternative prediction entries each associated with an alternative path of program flow;
storing the one or more alternative prediction entries; and
in response to a flush signal indicative of the prediction being incorrect, generating an alternative prediction associated with the block of the at least one instruction based on the one or more alternative prediction entries.

19. A non-transitory computer-readable medium storing computer-readable code for fabrication of an apparatus comprising:
a branch predictor configured to generate a prediction associated with a branch instruction outcome for a block of at least one instruction, the branch predictor comprising:
lookup circuitry configured to perform a lookup of stored prediction information to identify a plurality of prediction entries associated with alternative paths of program flow, the plurality of prediction entries comprising a main prediction entry to be used for generating the prediction and one or more alternative prediction entries each associated with an alternative path of program flow;
prediction generation circuitry configured to generate the prediction based on the main prediction entry; and
alternative prediction storage circuitry configured to store the one or more alternative prediction entries identified by the lookup circuitry; in which
responsive to a flush signal indicative of the prediction being incorrect, the prediction generation circuitry is configured to generate an alternative prediction associated with the block of the at least one instruction based on the one or more alternative prediction entries stored by the alternative prediction storage circuitry.
